(19) United States
(12) Patent Application Publication
(10) Pub. No.: US 2011/0191348 A1
(43) Pub. Date: Aug. 4, 2011

(54) METHOD OF INDEXING DATA IN DATA STORAGE DEVICE AND APPARATUSES USING THE METHOD

(75) Inventors: Jin-Woo Kim, Suwon-si (KR); Jun-Cheol Kim, Suwon-si (KR)

(73) Assignee: Samsung Electronics Co., Ltd., Suwon-si (KR)

(21) Appl. No.: 13/019,674

(22) Filed: Feb. 2, 2011

(30) Foreign Application Priority Data
Feb. 3, 2010 (KR) 2010-0009892

(51) Int. Cl. G06F 17/30

(52) U.S. Cl. 707/741; 707/769; 707/E17.002; 707/E17.014

(57) ABSTRACT

A method of indexing data in a data storage device includes generating index information of data using the data storage device and storing the index information in a storage region using the data storage device.

### CROSS-REFERENCE TO RELATED APPLICATIONS

This application claims the benefit of priority under 35 U.S.C. §119(a) from Korean Patent Application No. 10-2010-0009892, filed on Feb. 3, 2010, in the Korean Intellectual Property Office, the disclosure of which is incorporated herein in its entirety by reference.

### BACKGROUND

1. Field of the Invention

The present general inventive concept relates to a data storage device, and more particularly, to a method of indexing data in a data storage device and apparatuses using the method.

2. Description of the Related Art

Data indexing is performed by hosts. When performing the data indexing, host uses system resources, and therefore, the system resources cannot be efficiently used.

In addition, different operating systems can be used with a single host, a special indexing program suitable for operating system needs to be installed in the host. Accordingly, data indexing is dependent on the operating system of the host.

### SUMMARY

The present general inventive concept provides a method of indexing data in a data storage device and apparatuses using the method.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a method of indexing data in a data storage device. The method may include generating index information of data using the data storage device and storing the index information in a storage region using the data storage device.

The index information may include at least one among a file name, a file format, an owner, a creation date, and revision date of the data.

The method may further include receiving a request signal, which requests transmission of the index information, from a host, and transmitting the index information to the host in response to the request signal.

The method may further include generating a storage region to store the index information using the data storage device.

The generating the index information may include analyzing a file system and reading data information according to an analysis result using a file system module, and analyzing the data information, indexing the data information according to an analysis result, and generating the index information using an indexing module. The data information may include at least one among a file name, a creation date and revision date of the data.

According to other embodiments of the present general inventive concept, there is provided a data storage device including a controller configured to generate index information of data and a storage region configured to store the index information.

The controller may include a file system module configured to analyze a file system and read data information according to an analysis result, and an indexing module configured to analyze the data information, index the data information according to an analysis result, and generate the index information.

Features and/or utilities of the present general inventive concept may also be realized by a data storage system including a host configured to search for data and a data storage device configured to generate index information and transmit the index information to the host in response to a request signal received from the host requesting transmission of the index information.

Features and/or utilities of the present general inventive concept may also be realized by a data storage system including a host including memory to store a file system to input and output a file to and from the data storage system and a data storage device connected to the host. The data storage device may include a storage region to store data including the file and a controller including a file system module to generate index information based on the file system of the host to index the file stored in the storage region.

The controller may further include an indexing module to receive file data from the file system module corresponding to the file system of the host, and to generate the index information based on the file data received from the indexing module.

The host may include a search module to request index information from the data storage device.

The data storage device may include one or more memory devices having stored therein the storage region and the index information, a central processing unit to receive data and commands and to access the one or more memory devices according to the commands, and an interface to connect to the host to transmit data between the data storage device and the host.

Features and/or utilities of the present general inventive concept may also be realized by a method of storing data including determining with a host whether index information exists in a data storage device to store a file from the host and, when it is determined by the host that the index information does not exist in the data storage device, analyzing a file system of the host to generate the index information in the data storage device.

The method may further include storing the index information in the data storage device.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a software block diagram of a data storage system including a data storage device according to some embodiments of the present general inventive concept;

FIG. 2 is a hardware block diagram of the data storage system including the data storage device according to some embodiments of the present general inventive concept;

FIG. 3 is a flowchart of the operations of the data storage device illustrated in FIG. 1; and

FIG. 4 is a flowchart of the operations of the data storage system illustrated in FIG. 1.

### DETAILED DESCRIPTION OF THE EMBODIMENTS

The present general inventive concept now will be described more fully hereinafter with reference to the accompanying drawings, in which embodiments of the general inventive concept are shown. This general inventive concept may, however, be embodied in many different forms and should not be construed as limited to the embodiments set forth herein. Rather, these embodiments are provided so that this disclosure will be thorough and complete, and will fully convey the scope of the general inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present application, and will not be interpreted in an idealized or overly formal sense unless expressly so defined herein.

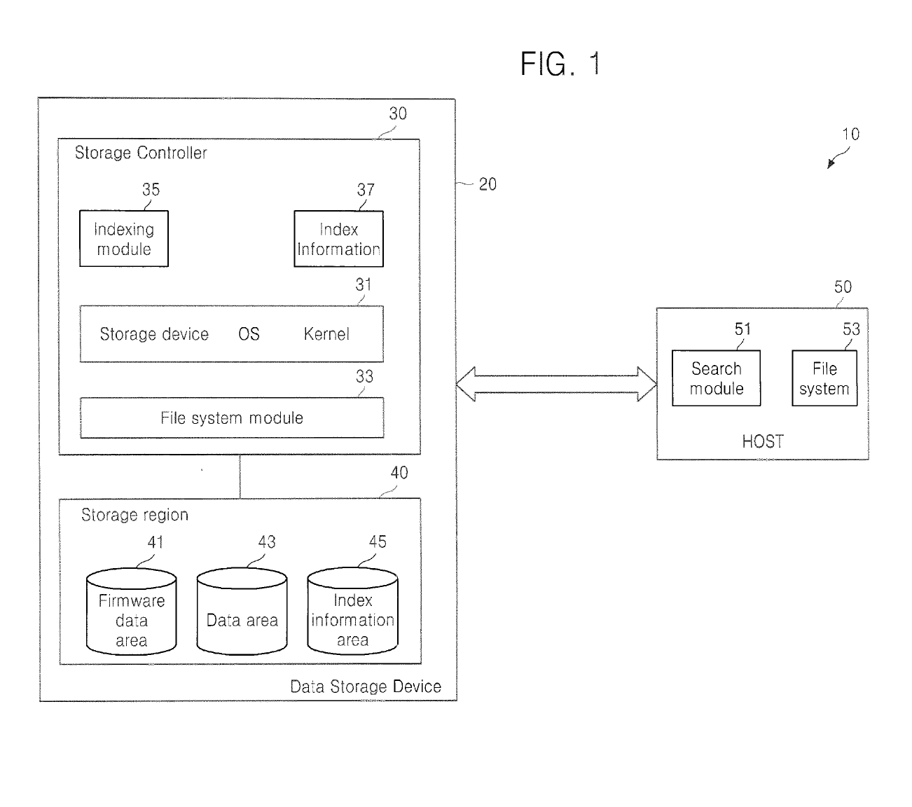

FIG. 1 is a block diagram of a data storage system 10 including a data storage device 20 according to some embodiments of the present general inventive concept. The data storage system 10 includes the data storage device 20 and a host 50.

The data storage system 10 may be any consumer equipment capable of processing or storing data. For example, consumer equipment may be hard disk drive (HDD) recorder, a tablet personal computer (PC), a cellular phone, a portable personal communication terminal such as a smart phone or a personal digital assistant (PDA), a computer such as a PC or notebook PC, a navigator device, a home automatic system, a music player such as an MP3 player, a camcorder, a video player such as a DVIX player, a storage server, or a portable multimedia player (PMP).

The data storage device 20 includes a controller 30 and a storage region 40. The controller 30 may include one or more processors, memory, logic devices, and other supporting circuitry. The storage region 40 may include one or more memory devices and supporting circuitry.

The controller 30 controls the operations of the data storage device 20, for example, the input/output of data to/from the host 50, an operation of reading data from the storage region 40, and an operation of generating index information of data. The controller 30 includes a storage device operating system (OS) kernel 31, a file system module 33, an indexing module 35, and indexing information 37.

The storage device OS kernel 31 is a central element that operates the data storage device 20. The storage device OS kernel 31 enables communication between a hardware layer and a utility layer. The hardware layer may be actual data processed in the storage region 40 and the utility layer may be the file system module 33. The file system module 33 analyzes a file system 53 and reads data information from the storage region 40 according to the analysis result.

The file system 53 performs the input/output of a file in the data storage system 10. For instance, the file system 53 names a file and determines where to logically put the file for storage or search. The file system 53 may be implemented by at least one among a file allocation table (FAT), a FAT32, an exFAT, a new technology file system (NTFS), and an ext2/3/4. The file system 53 may have a different architecture. For instance, a FAT12 uses 12 bits to represent a cluster and a FAT16 uses 16 bits. A cluster is a logical unit in which data is read or written.

The indexing module 35 analyzes the data information read by the file system module 33, indexes the data information according to the analysis result, and generates the index information 37. The data information may include a file name, a creation date, and a revision date of data. The data information to be analyzed may be decided by a user. After once generating the index information 37, the indexing module 35 may analyze only data information that has been changed based on a revision date and indexes the changed data information to increase an indexing speed.

The index information 37 includes information about the attributes and the content of data according to the analyzed data information. For instance, the index information 37 may include at least one among the file name, the file format, the owner, the creation date, and revision date of the data. The data information may be analyzed using a hash algorithm.

The indexing may be performed in an idle mode or during a certain period set by a user. Since the indexing is performed in the data storage device 20, the indexing is not dependent on the OS of the data storage system 10 and the load on the host 50 is also reduced.

The storage region 40 indicates volatile or non-volatile memory that is capable of storing, reading or erasing data or storing the index information 37. The storage region 40 may be implemented by an HDD, read-only memory (ROM), programmable ROM (PROM), erasable PROM (EPROM), electrically erasable PROM (EEPROM), flash memory, ferroelectric random access memory (FRAM), magnetic RAM (MRAM), phase change RAM (PRAM), nano RAM (NRAM), silicon-oxide-nitride-oxide-silicon (SONOS), resistive memory, or a racetrack memory. The storage region 40 includes a firmware data area 41, a data area 43, and an index information area 45.

The firmware data area 41 stores files necessary to operate the data storage device 20. The data area 43 includes a file area and a directory area. The file area stores actual files or data. The directory area stores information on a file stored in the file area, for example, the position of a start cluster and a file name. The data area 43 is divided into a plurality of clusters each of which may include a plurality of sectors. The index information area 45 stores the index information generated by the indexing module 35. When an area for storing the index information 37 does not exist in the storage region 40, the controller 30 generates the index information area 45 in the storage region 40 to store the index information 37.

The host 50 may be any device, e.g., a micro control unit or chipset, which can control the operation, e.g., the write, read, program or erase operation, of the data storage device 20. The host 50 includes a search module 51 and the file system 53.

The search module 51 searches for data wanted by a user. The file system 53 performs the input/output of a file in the data storage system 10. The communication between the host 50 and the data storage device 20 may be performed using a serial advanced technology attachment (SATA) communication protocol.

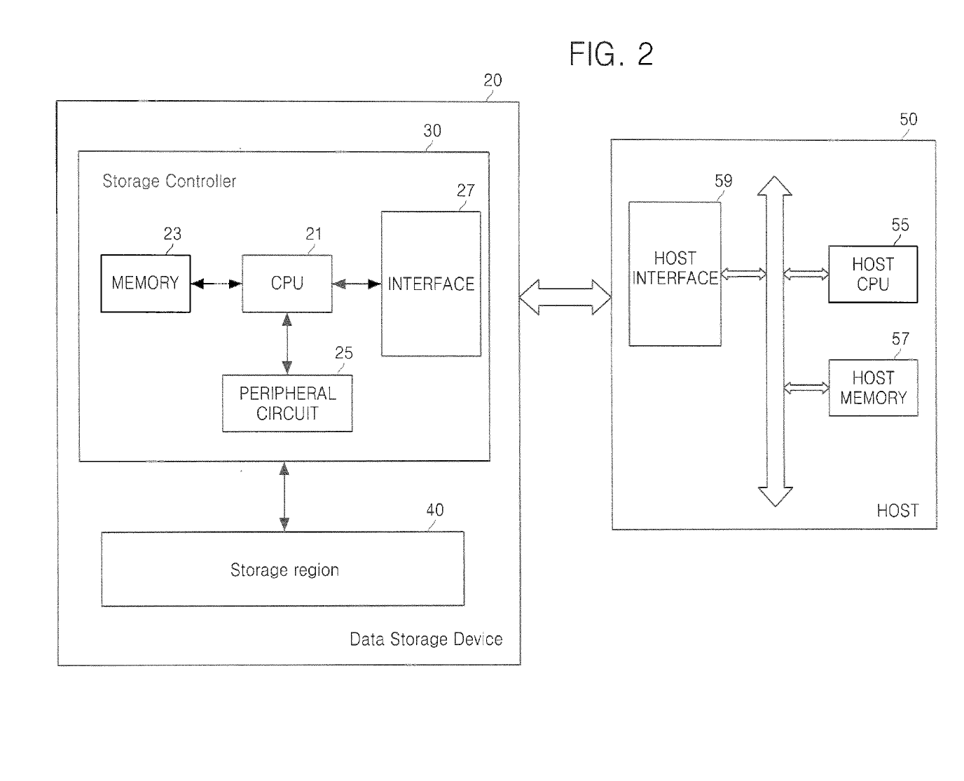

FIG. 2 is a hardware block diagram of a data storage system including the data storage device 20 according to some embodiments of the present general inventive concept. Referring to FIGS. 1 and 2, the controller 30 includes a central processing unit (CPU) 21, a memory 23, a peripheral circuit 25, and an interface 27.

The CPU 21 may read a program code from the memory 23 to execute a data indexing operation and may execute the program code to perform the data indexing. The program code may be the storage device OS kernel 31, the file system module 33, or the indexing module 35. The memory 23 may be implemented by volatile or non-volatile memory.

The peripheral circuit 25 includes every circuit necessary to read and write data or the index information 37 from and to the storage region 40. For instance, when the storage region 40 is an HDD, the peripheral circuit 25 includes devices such as a spindle motor, a voice coil motor, and a magnetic head, which are not shown in the drawings.

The index information 37 generated by the index module 35 may be transmitted to the host 50 via the interface 27. The CPU 21, the memory 23, the peripheral circuit 25, and the interface 27 may be implemented in a single chip, e.g. a system-on-chip (SoC).

The host 50 includes a host CPU 55, a host memory 57, and a host interface 59. The host CPU 55 controls the operation of the host 50. When a user requests to search for a file, the host CPU 55 may send an index information transmission request command to the interface 27 of the data storage device 20 via the host interface 59. The host memory 57 may store the search module 51, the file system 53, and the index information 37 received from the data storage device 20.

In the embodiments illustrated in FIGS. 1 and 2, the data storage device 20 may be a device dedicated only to data storage. For example, the device may be a chipset including a memory chip and a processor. The memory chip may store index information, firmware or other information to control operation of the processor, and one or more data storage areas to store files of the host 50. The storage region 40 of the data storage device may include other types of memory devices, such as magnetic or optical disks. The data storage device 20 may be a separate device from the host 50, so that it can be connected to or disconnected from the host 50. The data storage device 20 may be connected to the host 50 via a data port, such as a USB port, SATA port, wireless port, or any other type of data port.

The host 50 may include a CPU 55 and memory 57 and may access the data stored in the data storage device 20 via the data port. For example, each of the data storage device interface 27 and the host interface 59 may include data ports connected to each other by leads, wires, or wirelessly. The host 50 may be capable of performing other functions unrelated to storing data in the data storage device 20. For example, if the storage system is a PC, the host 50 may control video and audio operations and user programs of the PC. The host 50 may access files located on the data storage device 20 to carry out the respective programs.

Since the data storage device 20 includes at least one dedicated file or data storage area to store index information 37, and since the data storage device 20 generates its own index information, the data storage device 20 allows the host 50 to operate other programs more efficiently by freeing up processing power of the host 50 that may otherwise have been used to generate index information.

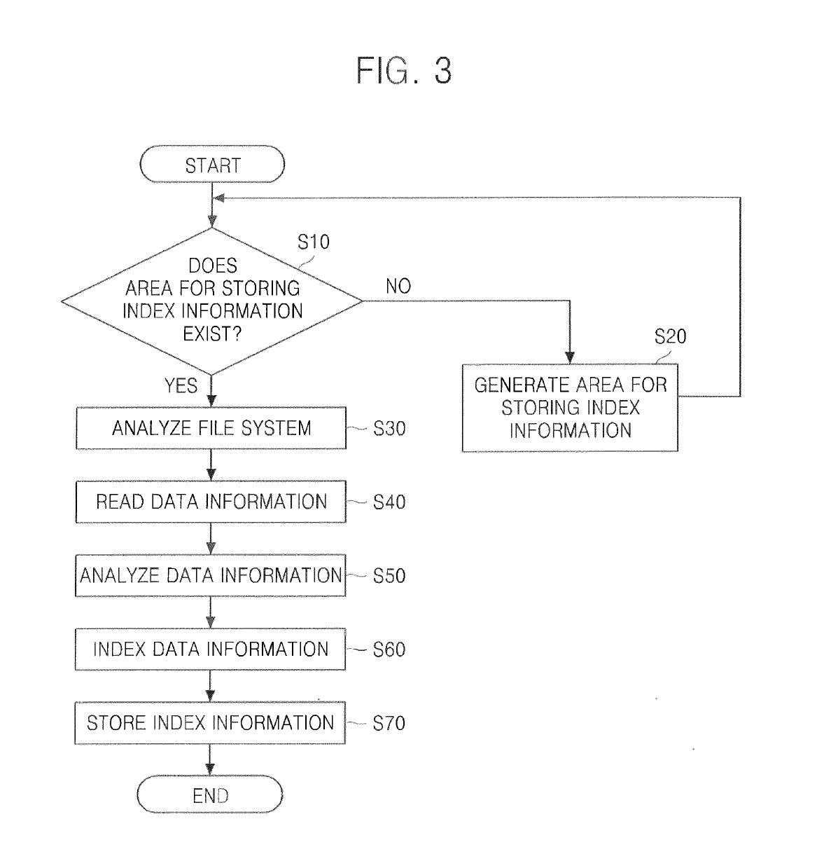

FIG. 3 is a flowchart of the operations of the data storage device 20 illustrated in FIG. 1. The operations of the data storage device 20 will be described with reference to FIGS. 1 through 3 below.

In operation S10, the controller 30 determines whether an area for storing the index information 37 exists in the storage region 40. When it is determined that the area for storing the index information 37 does not exist in the storage region 40, the controller 30 generates in operation S20 the index information area 45 for storing the index information 37.

When it is determined that the area for storing the index information 37 exists in the storage region 40, the file system module 33 in operation S30 analyzes the file system 53 of the OS of the host 50 and, in operation S40, reads data information from the host 50 according to the analysis result. The file system module 33 may control various types of file systems.

The indexing module 35 analyzes the data information in operation S50 and indexes the data information according to the analysis result to generate the index information 37 in operation S60. The analysis of the data information may be performed using a hash algorithm, for example. In operation S70, the controller 30 stores the index information 37 in the index information area 45.

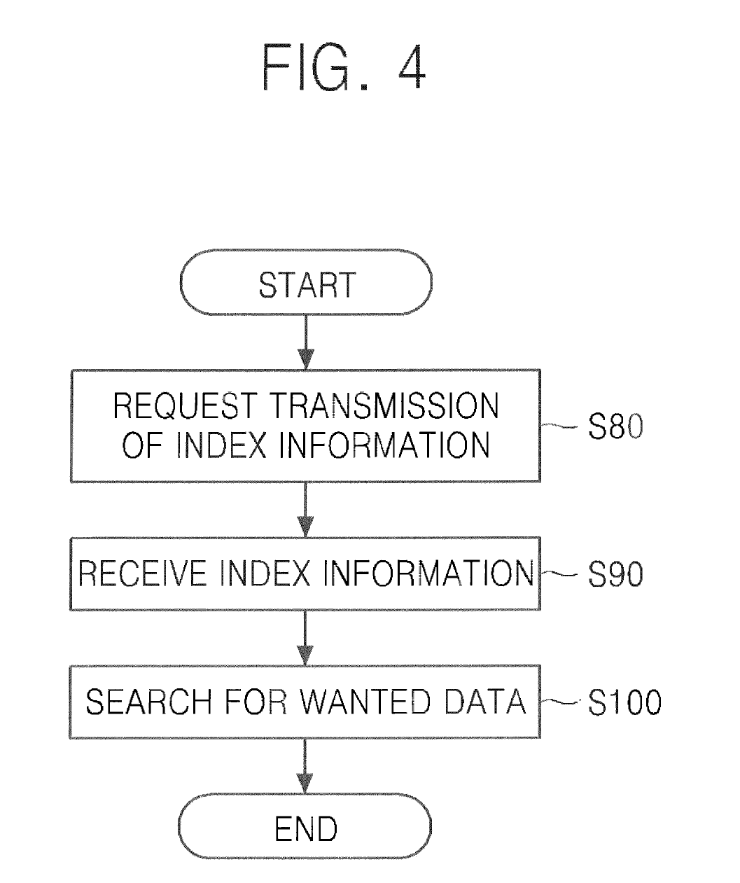

FIG. 4 is a flowchart of the operations of the data storage system 10 illustrated in FIG. 1. The operations of the data storage system 10 will be described with reference to FIGS. 1 through 4 below.

When a user requests data search, the host 50, in operation S80, requests the data storage device 20 to send the index information 37 to the host 50. In response to the request of the host 50, the index information 37 is transmitted in operation S90 to the interface 59 of the host 50 via the interface 27 of the data storage device 20. After being generated by the indexing module 35, the index information 37 may be stored in the index information area 45 of the data storage device 20 before being transmitted or may be directly transmitted by the indexing module 35.

The host 50 receives and stores the index information 37 in the memory 57. The host 50 searches for data requested by the user according to the index information 37 stored in the memory 57 and provides the data to the user in operation S100.

As described above, according to some embodiments of the present general inventive concept, data indexing is performed by a data storage device, so that system resources such as hosts can be efficiently used. In addition, a method of indexing data in a data storage device and apparatuses using the method are independent from hosts.

While the present general inventive concept has been particularly shown and described with reference to exemplary embodiments thereof, it will be understood by those of ordinary skill in the art that various changes in forms and details may be made therein without departing from the spirit and scope of the present general inventive concept as defined by the following claims.

1. A method of indexing data in a data storage device, the method comprising:
generating, by the data storage device, index information of data; and
storing, by the data storage device, the index information in a storage region.

2. The method of claim 1, wherein the index information comprises at least one among a file name, a file format, an owner, a creation date and revision date of the data.

3. The method of claim 1, further comprising:
receiving a request signal, which requests transmission of the index information, from a host; and
transmitting the index information to the host in response to the request signal.

4. The method of claim 1, further comprising generating, by the data storage device, the storage region for storing the index information.

5. The method of claim 1, wherein the generating the index information comprises:
analyzing, by a file system module, a file system and reading data information according to an analysis result; and
analyzing, by an indexing module, the information, indexing the data information according to an analysis result, and generating the index information.

6. The method of claim 5, wherein the data information comprises at least one among a file name, a creation date, and revision date of the data.

7. A data storage device comprising:
a controller configured to generate index information of data; and
a storage region configured to store the index information.

8. The data storage device of claim 7, wherein the index information comprises at least one among a file name, a file format, an owner, a creation date, and revision date of the data.

9. The data storage device of claim 7, wherein the controller comprises:
a file system module configured to analyze a file system and read data information according to an analysis result; and
an indexing module configured to analyze the data information, index the data information according to an analysis result, and generate the index information.

10. The data storage device of claim 9, wherein the data information comprises at least one among a file name, a creation date, and revision date of the data.

11. A data storage system comprising:
a host configured to search for data; and
a data storage device configured to generate index information and transmit the index information to the host in response to a request signal received from the host requesting transmission of the index information.

12. The data storage system of claim 11, wherein the index information comprises at least one among a file name, a file format, an owner, a creation date, and revision date of the data.

13. The data storage system of claim 11, wherein the data storage device comprises:
a controller configured to generate the index information of the data; and
a storage region configured to store the index information.

14. The data storage system of claim 13, wherein the controller comprises:
a file system module configured to analyze a file system and read data information according to an analysis result; and
an indexing module configured to analyze the data information, index the data information according to an analysis result, and generate the index information.

15. The data storage system of claim 14, wherein the data information comprises at least one among a file name, a creation date and revision date of the data.

16. The data storage system of claim 11, wherein the host comprises a search module configured to search for the data according to the index information.

17-20. (canceled)

21. A method of storing data, comprising:
determining with a host whether index information exists in a data storage device to store a file from the host; and
when it is determined by the host that the index information does not exist in the data storage device, analyzing by the data storage device a file system of the host to generate the index information in the data storage device.

22. The method of storing data of claim 20, further comprising storing the index information in the data storage device.
